(19) United States
(12) Patent Application Publication
(10) Pub. No.: US 2025/0083261 A1
(43) Pub. Date: Mar. 13, 2025

(54) BRAZING SHEETS, ARTICLES FORMED FROM BRAZING SHEETS, AND METHODS OF FORMING ARTICLES

(71) Applicant: ARCONIC TECHNOLOGIES LLC, Pittsburgh, PA (US)

(72) Inventors: Andreas K. KULOVITS, Pittsburgh, PA (US); Harry R. ZONKER, Oakmont, PA (US)

(21) Appl. No.: 18/552,941

(22) PCT Filed: Mar. 29, 2022
(86) PCT No.: PCT/US2022/071402

§ 371 Date: Sep. 28, 2023

Related U.S. Application Data
(60) Provisional application No. 63/175,284, filed on Apr. 15, 2021.

(51) Int. Cl. B23K 35/02; B23K 35/28; B23K 101/14

(52) U.S. Cl. CPC B23K 35/0238; B23K 35/286; B23K 2101/14

(57) ABSTRACT

Brazing sheets, articles formed from brazing sheets, and methods of forming articles are provided. In certain embodiments, a brazing sheet comprises a core comprising an aluminum alloy and a brazing layer comprising a 4XXX series aluminum alloy. The brazing layer is disposed on the core. The core acts as a sacrificial anode and the brazing layer acts as a cathode of a first galvanic circuit within the brazing sheet.

### FIELD OF USE

The present disclosure relates to brazing sheets, articles formed from or including brazing sheets, and methods of forming articles.

### BACKGROUND

Various apparatus, such as, for example, heat exchangers may be formed from stacked specially-designed metal plates. Plate-type heat exchangers function by circulating two fluids on opposite sides of a plate, allowing heat exchange between the fluids. To ensure that plate-type heat exchangers have acceptable corrosion resistance, the apparatus may be designed to resist corrosion attack along the joints between plates and through the thickness of the sheet material used to form the plates. Increasing the resistance to corrosion attack in plate-type heat exchangers can present significant challenges.

### SUMMARY

One non-limiting aspect according to the present disclosure is directed to a brazing sheet comprising a core and a brazing layer disposed on the core. In various non-limiting embodiments, the brazing sheet has a construction that is suitable for at least one of controlled atmospheric brazing and vacuum brazing. The core of the brazing sheet comprises an aluminum alloy, such as, for example, a 1XXX series aluminum alloy, a 3XXX series aluminum alloy, a 5XXX series aluminum alloy, or a 6XXX series aluminum alloy. For example, the core can comprise an aluminum alloy comprising, in weight percentages: up to 2.0 Si; up to 0.8 Fe; up to 1.0 Cu; up to 1.8 Mn; up to 1.0 Mg; up to 2.0 Zn; up to 0.25 Cr; up to 0.15 Zr; aluminum; and impurities. The brazing layer of the brazing sheet comprises a 4XXX series aluminum alloy, such as, for example, an aluminum alloy comprising, in weight percentages: 5 to 15 Si; up to 2.0 Mg; up to 1.0 Fe; up to 3.0 Zn; up to 3.0 Cu; up to 1.0 Mn; up to 1.0 Ti; up to 0.01 Bi; aluminum; and impurities. The core acts as a sacrificial anode and the brazing layer acts as a cathode of a first galvanic circuit within the brazing sheet, increasing the corrosion resistance of the brazing sheet.

In a further non-limiting aspect according to the present disclosure, the brazing sheet further comprises an interliner layer intermediate the core and the brazing layer, and the interliner layer acts as a cathode of the galvanic circuit relative to the core and as an anode of the galvanic circuit relative to the brazing layer. In certain non-limiting embodiments, the core, the interliner layer, and the brazing layer are bonded together. In certain non-limiting embodiments, the interliner layer comprises an aluminum alloy comprising, in weight percentages: 0.05 to 1.5 Si; up to 2 Cu; up to 0.5 Zr; up to 0.8 Fe; up to 2 Mn; up to 3 Zn; up to 2 Mg; up to 0.3 Ti; up to 1 Cr; up to 0.5 Bi; aluminum; and impurities. In various non-limiting embodiments, the core comprises a first concentration of a first cathodic Material, the brazing layer comprises a second concentration of a second cathodic material, and the interliner layer comprises a third concentration of a third cathodic material. The third concentration and the second concentration are each greater than the first concentration, such as, for example, by at least 0.05 weight percent, by at least 0.1 weight percent, by at least 0.15 weight percent, or by at least 0.2 weight percent. The second concentration is greater than the third concentration, such as, for example, by at least 0.05 weight percent, by at least 0.1 weight percent, by at least 0.15 weight percent, or by at least 0.2 weight percent greater. In certain non-limiting embodiments, the first concentration is at least 0.1 weight percent. In certain non-limiting embodiments, the first cathodic material, the second cathodic material, and the third cathodic material are each individually selected from the group consisting of Cu, Zn, Mg, Mn, Si, Fe, Cr, Ti, Zr, V, Li and combinations thereof. For example, the first cathodic material, the second cathodic material, and the third cathodic material can be Cu. In various non-limiting embodiments, the core comprises, in weight percentages, 0.05 to 0.6 Cu, the brazing layer comprises, in weight percentages, 0.25 Cu to 1 Cu, and the interliner layer comprises, in weight percentages, 0.25 to 0.95 Cu. In certain non-limiting embodiments, the core comprises a first thickness in a range of 60% to 90% of a total thickness of the brazing sheet, the interliner layer comprises a second thickness in a range of 3% to 20% of the total thickness of the brazing sheet, and the brazing layer comprises a third thickness in a range of 3% to 20% of the total thickness of the brazing sheet. In various non-limiting embodiments, the brazing sheet further comprises a second brazing layer and a second interliner layer, and the core acts as a sacrificial anode and the second brazing layer acts as a cathode of a second galvanic circuit within the brazing sheet.

An additional non-limiting aspect according to the present disclosure is directed to a heat exchanger comprising a structural element comprising all or a portion of an embodiment of a brazing sheet according to the present disclosure. In certain non-limiting embodiments, the heat exchanger has a galvanic corrosion resistance determined under ASTM G85 Annex A3 (2019) of at least 20 days. In certain non-limiting embodiments, the heat exchanger is an oil cooler, a radiator, or a liquid cooled condenser.

Yet a further non-limiting aspect according to the present disclosure is directed to a method for forming an article. The method comprises contacting a first part comprising a first material with a second part comprising all or a portion of a brazing sheet according to the present disclosure. The first part is coupled to the second part by a process comprising at least one of controlled atmospheric brazing and vacuum brazing. In various non-limiting embodiments, the first material comprises aluminum or an aluminum alloy. In certain non-limiting embodiments, the article is a heat exchanger, such as, for example, an oil cooler, a radiator, or a liquid cooled condenser.

It is understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawing, wherein:

FIG. 1 is a schematic side elevational view of a non-limiting embodiment of a brazing sheet according to the present disclosure;

FIG. 2 is a schematic side elevational view of a non-limiting embodiment of a brazing sheet according to the present disclosure;

FIG. 3 is a block diagram of a non-limiting embodiment of a method according to the present disclosure for forming articles from brazing sheets;

FIG. 4 is a photomicrograph showing a cross-sectional side view of a portion of a comparative heat exchanger;

FIG. 5 is a photomicrograph showing a cross-sectional side view of a portion of a non-limiting embodiment of a heat exchanger comprising a non-limiting embodiment of a brazing sheet according to the present disclosure;

FIG. 6A is a photomicrograph showing a cross-sectional side view of a joint at a base plate of a non-limiting embodiment of a heat exchanger comprising a non-limiting embodiment of a brazing sheet according to the present disclosure;

FIG. 6B is a photomicrograph showing a cross-sectional side view of a portion of the heat exchanger of FIG. 6A that is positioned away from the joint of the base plate; and

FIG. 6C is a photomicrograph showing a cross-sectional side view of a shear edge of the heat exchanger of FIG. 6A.

The exemplifications set out herein illustrate certain embodiments, in one form, and such exemplifications are not to be construed as limiting the scope of the appended claims in any manner.

### DETAILED DESCRIPTION

Various embodiments are described and illustrated herein to provide an overall understanding of the structure, function, and use of the disclosed articles and methods. The various embodiments described and illustrated herein are non-limiting and non-exhaustive. Thus, an invention is not limited by the description of the various non-limiting and non-exhaustive embodiments disclosed herein. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, the applicant reserves the right to amend the claims to affirmatively disclaim features or characteristics that may be present in the prior art. The various embodiments disclosed and described in this specification can comprise, consist of, or consist essentially of the features and characteristics as variously described herein.

Any references herein to “various embodiments,” “some embodiments,” “one embodiment,” “an embodiment,” or like phrases mean that a particular feature, structure, or characteristic described in connection with the example is included in at least one embodiment. Thus, appearances of the phrases “in various embodiments,” “in some embodiments,” “in one embodiment,” “in an embodiment,” or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

Brazed joints can be susceptible to galvanic corrosion due to a galvanic difference between the composition of the brazing layer and the composition of a material that is coupled to (e.g., galvanically coupled to) the brazing layer (e.g., the core or the interliner layer). As used herein, “galvanic difference” means an electrochemical potential difference (e.g., a corrosion potential difference) between one region (e.g., layer) and another region. The electrochemical potential difference between the regions can be due to a difference in the compositions of the regions. Without being bound to a particular mechanism or theory, in some non-limiting embodiments, when two regions having an electrochemical potential difference are coupled together and are in the presence of an electrolyte, one region will act as the anode of a galvanic circuit, while the other region will act as the cathode of the galvanic circuit. As used herein, “anodic” or “anode” refers to region having a composition that is more electronegative than another region. As used herein, “cathodic” or “cathode” refers to region having a composition that is less electronegative than another region.

To improve the corrosion resistance of brazed joints and thereby increase the operational life of articles comprising the brazed joints, the present disclosure provides a brazing sheet comprising a core and a brazing layer disposed on the core wherein the core acts as a sacrificial anode and the brazing layer acts as a cathode of a first galvanic circuit within the brazing sheet. In this way, corrosion attack is inhibited at the brazing layer and directed to the core of the brazing sheet. In various non-limiting embodiments, typically, only the edge of the core is exposed, and the corrosion attack to the core will likely by localized to this edge. The rate of corrosion attack at the edge is reduced compared to previous corrosion attack along the brazing joint or perpendicular through the wall thickness of the core. Additionally, the core, typically, is thicker than the brazing layer and protected by the braze layer and interliner layer (if used) and, therefore, is better able to withstand corrosion than the, typically, thinner brazing layer. Thus, embodiments of brazing sheets provided herein can provide enhanced corrosion performance and increased operational life of articles made from or incorporating the brazing sheets.

As used herein, the term “core” refers to a substrate layer of the brazing sheet. In various non-limiting embodiments, the “core” can be disposed substantially in the center of a brazing sheet. However, the position of the core in a brazing sheet according to the present disclosure is not limited to the center of a brazing sheet. The core may or may not be covered on both of its faces with another layer of the brazing sheet and, for example, the core can be disposed on one side of the brazing sheet. Accordingly, in various non-limiting embodiments, the core can be surrounded by other layers of the brazing sheet, have at least one side at least partially exposed, or have at least one side fully exposed.

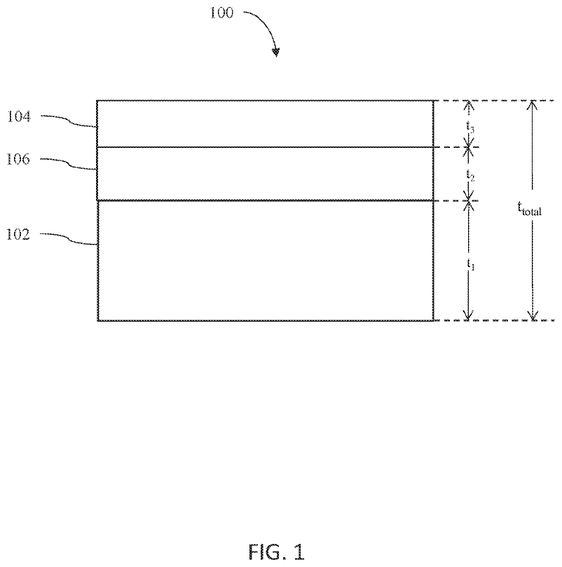

Referring to FIG. 1, a brazing sheet 100 is provided. The brazing sheet 100 comprises a core 102, a brazing layer 104 disposed on the core 102 and, optionally, an interliner layer 106 disposed intermediate the core 102 and the brazing layer 104. In various non-limiting embodiments, the core 102, the interliner layer 106, and the brazing layer 104 are bonded together. The brazing sheet 100 can have a composition and thickness suitable for at least one of controlled atmospheric brazing and vacuum brazing.

To enhance the corrosion resistance of the brazing layer 104, the core 102 acts as a sacrificial anode and the brazing layer 104 acts as a cathode of a galvanic circuit within the brazing sheet 100. For example, the composition of the core 102 can be more anodic than a composition of the brazing layer 104. In various non-limiting embodiments, an electrochemical potential difference between the core 102 and the brazing layer 104 can be at least 1 mV, such as, for example, at least 2 mV, at least 5 mV, at least 10 mV, at least 15 mV, at least 20 mV, at least 30 mV, at least 40 mV, at least 50 mV, at least 60 mV, at least 70 mV, at least 80 mV, at least 90 mV, at least 100 n, at least 120 mV, at least 130 mV, at least 140 mV, or at least 150 mV. In various non-limiting embodiments, an electrochemical potential difference between the core 102 and the brazing layer 104 can be no greater than 1000 mV, such as, for example, no greater than 500 mV, no greater than 250) mV, no greater than 150 mV, or no greater than 100 mV. For example, the electrochemical potential difference between the core 102 and the brazing layer 104 can be in a range of 1 mV to 1000 mV, such as, for example 5 mV to 500 mV, 5 mV to 10 mV, Sn V to 100 mV, 10 mV to 100 mV, 10 mV to 250 mV, or 50 mV to 500 mV.

In various non-limiting embodiments, the interliner layer 106 acts as a cathode of the galvanic circuit relative to the core 102. The interliner layer 106 can comprise the same electronegative potential as the brazing layer 104 or act as an anode of the galvanic circuit relative to the brazing layer 104. For example, the composition of the interliner layer 106 can be more anodic than a composition of the brazing layer 104 and more cathodic than the composition of the core 102. In various non-limiting embodiments, regardless of the number of layers in the brazing sheet 100, a gradient of galvanic potential can be configured within the brazing sheet 100 in which the core 102 is the most anodic of the layers and the brazing layer 104 is the most cathodic of the layers.

In order to configure the galvanic circuit within the brazing sheet 100, the core 102 comprises a first concentration of a first cathodic material, the brazing layer 104 comprises a second concentration of a second cathodic material, and the interliner layer 106 comprises a third concentration of a third cathodic material. The second concentration can be greater than the first concentration. The third concentration can be greater than the first concentration and less than the second concentration. As used herein, a “cathodic material” may be an element or a combination of elements that can increase the electronegativity of the respective layer when present in the layer.

The first cathodic material, the second cathodic material, and the third cathodic material can be the same or different and in various non-limiting embodiments are each individually selected from the group consisting of Cu, Zn, Mg, Mn, Si, Fe, Cr, Ti, Zr, V, Li and combinations thereof. In various examples, the first cathodic material, the second cathodic material, and the third cathodic material can be the same in order to limit interdiffusion between the layers in the brazing sheet during a brazing cycle. In various non-limiting embodiments, the first cathodic material, the second cathodic material, and the third cathodic material are individually selected from the group consisting of Cu, Zn, and Mg. In certain non-limiting embodiments, the first cathodic material, the second cathodic material, and the third cathodic material are Cu. In various non-limiting embodiments, the first cathodic material, the second cathodic material, and the third cathodic material are a mixture of at least two elements each individually selected from the group consisting of Cu, Zn, Mg, Mn, Si, Fe, Cr, Ti, Zr, V, and Li. In certain other non-limiting embodiments, the first cathodic material is Zn and the second cathodic material and the third cathodic material are Cu.

In various non-limiting embodiments, the third concentration can be greater than the first concentration by at least 0.05 weight percent, such as, for example, by at least 0.1 weight percent, by at least 0.15 weight percent or by at least 0.2 weight percent. In various non-limiting embodiments, the second concentration can be greater than the third concentration by at least 0.05 weight percent, such as, for example, by at least 0.1 weight percent, by at least 0.15 weight percent, or by at least 0.2 weight percent. In various non-limiting embodiments, the core 102 comprises at least 0.01 weight percent of the first cathodic material. In various non-limiting embodiments in which the first cathodic material, the second cathodic material, and third cathodic material are Cu, the first concentration can be in a range of 0.05 to 0.2 weight percent Cu, the second concentration can be in a range of 0.5 to 1 weight percent Cu, and the third concentration can be in a range of 0.2 to 0.5 weight percent Cu. In various non-limiting embodiments, starting with the core 102 and advancing through the thickness of the brazing sheet 100 toward the brazing layer 104, the concentration of the cathodic material increases with each subsequent layer.

Again referring to FIG. 1, the core 102 of the brazing sheet 100 comprises an aluminum alloy, such as, for example, a 1XXX series aluminum alloy, a 3XXX series aluminum alloy, a 5XXX series aluminum alloy, or a 6XXX series aluminum alloy. In various non-limiting embodiments, the core 102 comprises an aluminum alloy comprising, in weight percentages: up to 2.0 Si; up to 0.8 Fe; up to 1.0 Cu; up to 1.8 Mn; up to 1.0 Mg; up to 2.0 Zn; up to 0.25 Cr; up to 0.15 Zr; aluminum; and impurities.

Referring to FIG. 1, the brazing layer 104 of the brazing sheet 100 comprises an aluminum alloy, such as, for example, a 4XXX series aluminum alloy. In various non-limiting embodiments, the brazing layer 104 comprises an aluminum alloy comprising, in weight percentages: 5 to 15 Si; up to 2.0 Mg; up to 1.0 Fe; up to 3.0 Zn; up to 3.0 Cu; up to 1.0 Mn; up to 1.0 Ti; up to 0.01 Bi; aluminum; and impurities.

Referring to FIG. 1, the interliner layer 106 of the brazing sheet 100 comprises an aluminum alloy, such as, for example, an aluminum alloy comprising, in weight percentages: 0.05 to 1.5 Si; up to 2 Cu; up to 0.5 Zr; up to 0.8 Fe; up to 2 Mn; up to 3 Zn; up to 2 Mg; up to 0.3 Ti; up to 1 Cr; up to 0.5 Bi; aluminum; and impurities.

The thickness of each layer in the brazing sheet 100 can be configured based on the desired structural properties of the article to be produced from or incorporating the brazing sheet 100. For example, in various non-limiting embodiments the core 102 can comprise a first thickness, t₁, that can be in a range of 60% to 90% of a total thickness, i.e., tₜₒₜₐₗ, of the brazing sheet 100. In various non-limiting embodiments the interliner layer 106 can comprise a second thickness, t₂, that is in a range of 3% to 20% of a total thickness (tₜₒₜₐₗ) of the brazing sheet 100. In various non-limiting embodiments the brazing layer 104 can comprise a third thickness, t₃, that is in a range of 3% to 20% of the total thickness (tₜₒₜₐₗ) of the brazing sheet 100. In various non-limiting embodiments, the first thickness, t₁, is greater than the second thickness, t₂, and also is greater than the third thickness, t₃. In certain non-limiting embodiments, the total thickness (tₜₒₜₐₗ) of the brazing sheet 100 is in a range of 100 m to 5 mm, such as, for example, in a range of 200 m to 1 mm.

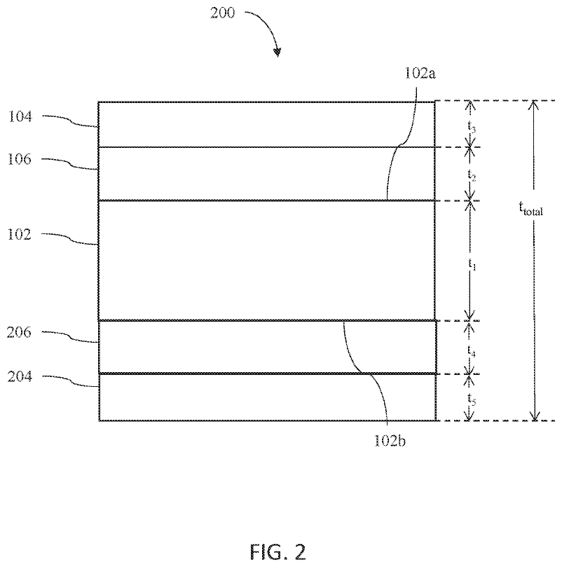

In various non-limiting embodiments, a brazing sheet according to the present disclosure may comprise layers in addition to a core, an interliner layer, and a brazing layer. For example, referring to the non-limiting embodiment shown schematically in FIG. 2, a brazing sheet 200 comprises core 102, first interliner layer 106, first brazing layer 104, second brazing layer 204, and second interliner layer 206. In various non-limiting embodiments, the core 102, first interliner layer 106, second interliner layer 206, first brazing layer 104, and second brazing layer 204 are bonded together to form the brazing sheet 200. The brazing sheet 200 can be suitable for at least one of controlled atmospheric brazing and vacuum brazing. For example, the brazing sheet 200 can comprise layers having compositions so that the brazing sheet is suitable for controlled atmospheric brazing and/or vacuum brazing.

As shown in FIG. 2, second brazing layer 204 is disposed on a second side 102b of core 102 and first brazing layer 104 is disposed on a first side 102a of core 102. The second side 102b of the core 102 is disposed opposite the first side 102a of the core 102. In various embodiments, the second brazing layer 204 can be configured with a composition as described herein with respect to the first brazing layer 104. In various non-limiting embodiments, a composition of the second brazing layer 204 can be the same as or different from a composition of the first brazing layer 104. Similarly, the second interliner layer 206 can be configured with a composition as described herein with respect to first interliner layer 106. In various non-limiting embodiments, a composition of the second interliner layer 206 can be the same as or different than a composition of the first interliner layer 106.

The second interliner layer 206 can be disposed intermediate the core 102 and the second brazing layer 204. To enhance corrosion resistance of the second brazing layer 204, the core 102 can act as a sacrificial anode and the second brazing layer 204 can act as a cathode of a second galvanic circuit within the brazing sheet 200.

A thickness of each layer in the brazing sheet 200 can be configured based on the desired structural properties of the article to be produced from or that incorporates the brazing sheet 200. For example, in various non-limiting embodiments the core 102 can comprise a first thickness, t₁, that can be in a range of 60% to 90% of a total thickness (tₜₒₜₐₗ) of the brazing sheet 200. In various non-limiting embodiments the first interliner layer 106 and second interliner layer 206 can comprise a combined thickness, t₂+t₄, that is in a range of 3% to 20% of the total thickness (tₜₒₜₐₗ) of the brazing sheet 200. In various non-limiting embodiments the first brazing layer 104 and the second brazing layer 204 can comprise a combined thickness, t₃+t₅, that is in a range of 3% to 20% of the total thickness (tₜₒₜₐₗ) of the brazing sheet 200. In certain non-limiting embodiments, the total thickness (tₜₒₜₐₗ) of the brazing sheet 200 is in a range of 100 m to 5 mm, such as, for example, in a range of 200 m to 1 mm.

In various non-limiting embodiments, an article such as, for example, a heat exchanger, can comprise a structural element comprising all or a portion of brazing sheet 100 and/or all or a portion of brazing sheet 200. The heat exchanger can have a galvanic corrosion resistance evaluated under ASTM G85 Annex A3 (2019) of at least 20 days, such as, for example, at least 25 days, or at least 30 days. The heat exchanger can be, for example, an oil cooler, a radiator, or a liquid cooled condenser.

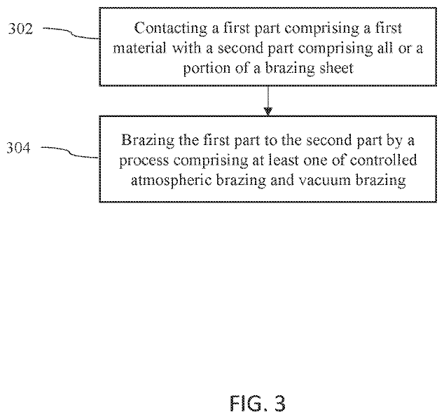

FIG. 3 provides a block diagram of a non-limiting embodiment of a method according to the present disclosure for forming an article such as, for example, a heat exchanger. The method comprises contacting a first part comprising a first material with a second part comprising all or a portion of an embodiment of a brazing sheet according to the present disclosure. For example, a non-limiting embodiment of a method according to the present disclosure may comprise contacting a first part comprising a first material with a second part comprising all or a portion of brazing sheet 100 and/or brazing sheet 200 (FIG. 3, step 302).

In various non-limiting embodiments, the first part can be brazed to the second part by a process comprising at least one of controlled atmospheric brazing and vacuum brazing (step 304). In various embodiments, step 304 comprises controlled atmospheric brazing, wherein a flux is or is not used. For example, if the first interliner layer 106 and/or the second interliner layer 206, and the core 102 comprises Mg, flux may not be required when conducting controlled atmospheric brazing. However, if the first interliner layer 106 and/or the second interliner layer 206, and the core 102 do not comprise Mg, flux may be required when conducting controlled atmospheric brazing. In various non-limiting embodiments, the first material comprises aluminum or an aluminum alloy.

### Examples

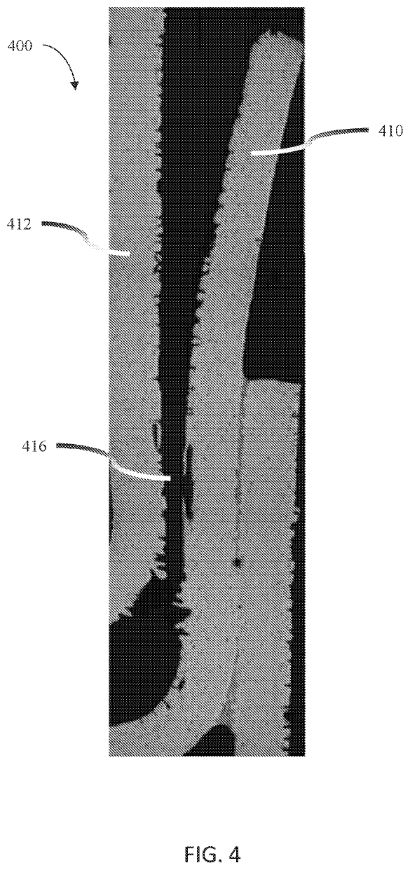

FIG. 4 is a photomicrograph of a cross-sectional side view of a portion of a comparative heat exchanger 400 after galvanic corrosion resistance testing under the procedure of ASTM G85 Annex A3 (2019). The comparative heat exchanger 400 was a stacked plate heat exchanger prepared by brazing together conventional brazing sheets in a conventional controlled atmospheric brazing process brazing process using flux. Each conventional brazing sheet comprised two external brazing layers comprising 4045 series aluminum alloy, two interliner layers comprising a first aluminum alloy, and a core comprising a second aluminum alloy. In the conventional brazing sheet, the composition of the two brazing layers was more anodic than the core in the conventional brazing sheet. The first aluminum alloy comprises in weight percentages: up to 0.3 Si; up to 0.2 Fe; up to 0.10 Cu; up to 0.1 Mn; up to 0.1 Mg; up to 0.05 Cr; 2.0 to 2.4 Zn; up to 0.05 Ti; aluminum; and impurities ( ). The second aluminum alloy comprises in weight percentages: up to 0.25 Si; up to 0.4 Fe; 0.5 to 0.6 Cu; 1.0 to 1.3 Mn; up to 0.05 Mg; up to 0.1 Zn; 0.1 to 0.2 Ti; aluminum; and impurities.

After brazing together the conventional brazing sheets to form the comparative heat exchanger 400, the comparative heat exchanger 400 was evaluated for galvanic corrosion resistance under the conditions ASTM G85 Annex A3 (2019) and failed after approximately 15 days of exposure. FIG. 4 shows a cross-section of a brazing sheet in the comparative heat exchanger after the 15 days of exposure. In particular, in area 416 in FIG. 4 a brazing layer of brazing sheet 410 has corroded to a degree that it is no longer connected to brazing sheet 412. That is, a brazing layer of the brazing sheets, 410 and 412, corroded to a degree that a brazed joint between brazing sheets 410 and 412 failed.

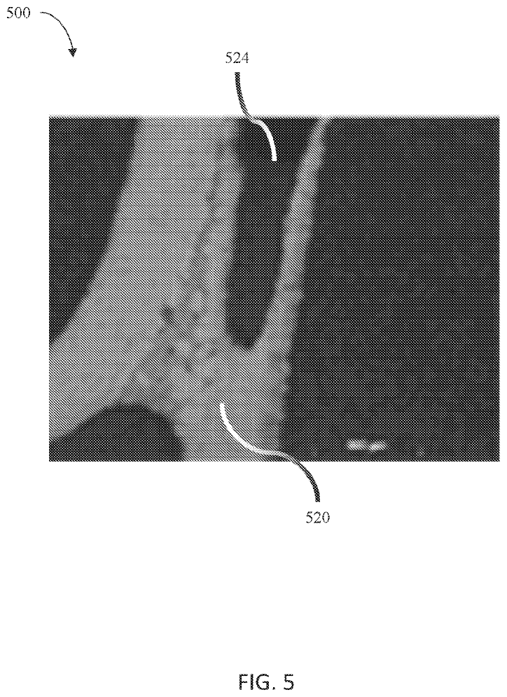

FIG. 5 is a photomicrograph of a cross-sectional side view of a portion of a heat exchanger 500 after galvanic corrosion resistance testing under the conditions ASTM G85 Annex A3 (2019). The heat exchanger 500 was a stacked plate heat exchanger comprising embodiments of brazing sheets according to the present disclosure. The heat exchanger 500 was prepared by brazing the brazing sheet embodiments together in a conventional controlled atmospheric brazing with flux. Each brazing sheet comprised first and second brazing layers comprising a 4045 series aluminum alloy including 0.55 wt. % Cu, first and second interliner layers comprising a third aluminum alloy including 0.35 wt. % Cu, and a core comprising a 3003 series aluminum alloy including 0.15 wt. % Cu. The composition of the two brazing layers was more cathodic than the core in the brazing sheet. The third aluminum alloy comprises, in weight percentages: up to 0.25 Si; up to 0.6 Fe; 0.2 to 0.4 Cu; 0.8 to 1.3 Mn; up to 0.1 Mg; up to 0.05 Zn; up to 0.25 Ti; up to 0.25 Zr; aluminum; and impurities

After brazing, the heat exchanger 500 was evaluated for corrosion resistance under the conditions of ASTM G85 Annex A3 (2019). As shown in FIG. 5, the heat exchanger 500 did not fail and remained operational after 30 days of exposure. Additionally, it was observed that the corrosion mode of heat exchanger 500 differed from that of comparative heat exchanger 400. In particular, instead of observing the joint and through-thickness corrosion attack exhibited by heat exchanger 400 shown in FIG. 4, corrosion in heat exchanger 500 mainly occurred at the core on the unprotected shear edge of the brazing layer 520, as shown in area 524 of FIG. 5. Corrosion of the brazing joint and the brazing layer of the brazing sheet in heat exchanger 500 was minimal after 30 days. Although heat exchanger 500 did experience some corrosion during the corrosion testing, the corrosion mainly occurred on the unprotected shear edge of the brazing layer, and no significant corrosion occurred at brazing joints.

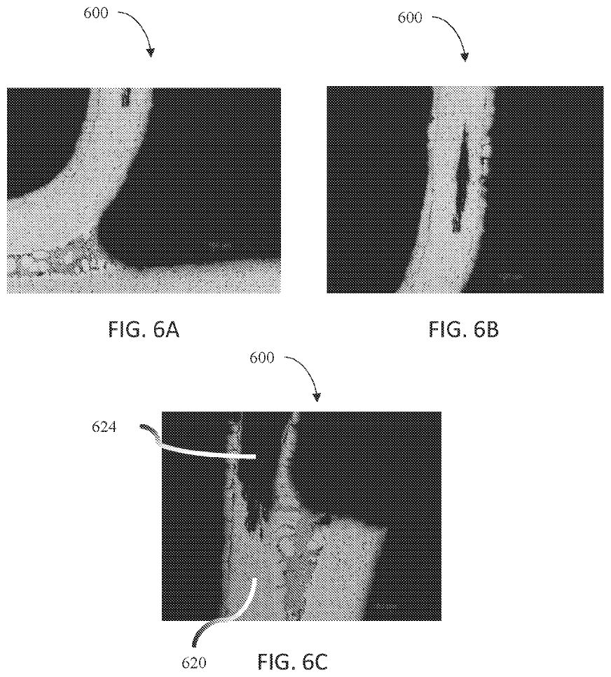

FIG. 6A-C are photomicrographs of cross-sectional side views of various portions of a heat exchanger 600 after galvanic corrosion resistance testing under the conditions ASTM G85 Annex A3 (2019). The heat exchanger 600 was a stacked plate heat exchanger comprising embodiments of brazing sheets according to the present disclosure. The heat exchanger 600 was prepared by brazing the brazing sheet embodiments together in a conventional controlled atmospheric brazing with flux. Each brazing sheet comprised first and second brazing layers comprising a 4045 series aluminum alloy including 0.41 wt. % Cu, first and second interliner layers comprising a third aluminum alloy including 0.29 wt. % Cu, and a core comprising a first aluminum alloy including 0.2 wt. % Cu. The composition of the two brazing layers was more cathodic than the core in the brazing sheet. The composition of each layer in the brazing sheets is shown in Table 1 below.

TABLE 1
Composition of each layer in the brazing sheets

| | | | | | | | | Al and |
|---|---|---|---|---|---|---|---|---|
| | Si | Fe | Mn | Cu | Mg | Ti | Zr | impurities |
| Layer | (wt %) | (wt %) | (wt %) | (wt %) | (wt %) | (wt %) | (wt %) | (wt %) |
| First and | 9.89 | 0.16 | — | 0.41 | — | — | — | Bal. |
| Second | | | | | | | | |
| Brazing | | | | | | | | |
| Layers | | | | | | | | |
| First and | 0.07 | 0.19 | 0.97 | 0.29 | 0.1 | 0.14 | 0.08 | Bal. |
| Second | | | | | | | | |
| Interliner | | | | | | | | |
| Layers | | | | | | | | |
| Core | 0.05 | 0.21 | 1.2 | 0.2 | — | 0.125 | — | Bal. |

After brazing, the heat exchanger 600 was evaluated for corrosion resistance under the conditions of ASTM G85 Annex A3 (2019). As shown in FIGS. 6A-C, the heat exchanger 600 did not fail and remained operational after 30 days of exposure. Additionally, it was observed that the corrosion mode of heat exchanger 600 differed from that of comparative heat exchanger 400. In particular, instead of observing the joint and through-thickness corrosion attack exhibited by heat exchanger 400 shown in FIG. 4, corrosion in heat exchanger 600 mainly occurred at the core on the unprotected shear edge of the brazing layer 620, as shown in area 624 of FIG. 6C. Corrosion of the brazing joint and the brazing layer of the brazing sheet in heat exchanger 600 was minimal after 30 days. Although heat exchanger 600 did experience some corrosion during the corrosion testing, the corrosion mainly occurred on the unprotected shear edge of the brazing layer, and no significant corrosion occurred at brazing joints.

The following numbered clauses are directed to various non-limiting embodiments and aspects according to the present disclosure.

1. A brazing sheet comprising:
a core comprising an aluminum alloy; and
a brazing layer disposed on the core and comprising a 4XXX series aluminum alloy;
wherein the core acts as a sacrificial anode and the brazing layer acts as a cathode of a first galvanic circuit within the brazing sheet.
   2. The brazing sheet of clause 1, further comprising:
an interliner layer intermediate the core and the brazing layer;
wherein the interliner layer acts as a cathode of the galvanic circuit relative to the core, and the interliner layer acts as an anode of the galvanic circuit relative to the brazing layer.
   3. The brazing sheet of clause 2, wherein
the core comprises a first concentration of a first cathodic material;
the brazing layer comprises a second concentration of a second cathodic material;
the interliner layer comprises a third concentration of a third cathodic material;
the second concentration is greater than the first concentration; and
the third concentration is greater than the first concentration and less than the second concentration.
   4. The brazing sheet of clause 3, wherein the first cathodic material, the second cathodic material, and the third cathodic material are each individually selected from the group consisting of Cu, Zn, Mg, Mn, Si, Fe, Cr, Ti, Zr, V, Li, and combinations thereof.
   5. The brazing sheet of clause 4, wherein the first cathodic material, the second cathodic material, and the third cathodic material are Cu.
   6. The brazing sheet of any one of clauses 3 to 5, wherein
the third concentration is greater than the first concentration by at least 0.05 weight percent; and
the second concentration is greater than the third concentration by at least 0.05 weight percent.
   7. The brazing sheet of any of clauses 3 to 6, wherein the core comprises at least 0.01 weight percent of the first cathodic material.
   8. The brazing sheet of any of clauses 2 to 7, wherein:
the core comprises, in weight percentages, 0.05 to 0.6 Cu;
the brazing layer comprises, in weight percentages, 0.25 Cu to 1 Cu; and
the interliner layer comprises, in weight percentages, 0.25 to 0.95 Cu.
   9. The brazing sheet of any of clauses 2 to 8, wherein the core, the interliner layer, and the brazing layer are bonded together.
   10. The brazing sheet of any of clauses 2 to 9, wherein the interliner layer is an aluminum alloy comprising, in weight percentages:
0.05 to 1.5 Si;
up to 2 Cu;
up to 0.5 Zr;
up to 0.8 Fe;
up to 2 Mn;
up to 3 Zn;
up to 2 Mg;
up to 0.3 Ti;
up to 1 Cr;
up to 0.5 Bi;
aluminum; and impurities.
   11. The brazing sheet of any of clauses 2 to 10, wherein:
the brazing layer is a first brazing layer disposed on a first side of the core;
the interliner layer is a first interliner layer;
the galvanic circuit is a first galvanic circuit;
a second brazing layer is disposed on a second side of the core, opposite the first side of the core, and comprises a 4XXX series aluminum alloy; and
a second interliner layer is disposed intermediate the core and the second brazing layer;
wherein the core acts as a sacrificial anode and the second brazing layer acts as a cathode of a second galvanic circuit within the brazing sheet.
   12. The brazing sheet of any of clauses 1 to 11, wherein the core comprises a 1XXX series aluminum alloy, a 3XXX series aluminum alloy, a 5XXX series aluminum alloy, or a 6XXX series aluminum alloy.
   13. The brazing sheet of any of clauses 1 to 12, wherein the brazing sheet is suitable for at least one of controlled atmospheric brazing and vacuum brazing.
   14. The brazing sheet of any of clauses 1 to 13, wherein the brazing layer is an aluminum alloy comprising, in weight percentages:
5 to 15 Si;
up to 2.0 Mg;
up to 1.0 Fe;
up to 3.0 Zn;
up to 3.0 Cu;
up to 1.0 Mn;
up to 1.0 Ti;
up to 0.01 Bi;
aluminum; and
impurities.
   15. The brazing sheet of any of clauses 1 to 14, wherein the core is an aluminum alloy comprising, in weight percentages:
up to 2.0 Si;
up to 0.8 Fe;
up to 1.0 Cu;
up to 1.8 Mn;
up to 1.0 Mg;
up to 2.0 Zn;
up to 0.25 Cr;
up to 0.15 Zr;
aluminum; and
impurities.
   16. The brazing sheet of any of clauses 1 to 15, wherein
the core comprises a first thickness in a range of 60% to 90% of a total thickness of the brazing sheet;
the interliner layer comprises a second thickness in a range of 3% to 20% of the total thickness of the brazing sheet; and
the brazing layer comprises a third thickness in a range of 3% to 20% of the total thickness of the brazing sheet.
   17. A heat exchanger comprising a structural element comprising all or a portion of the brazing sheet of any of clauses 1 to 16.
   18. The heat exchanger of any of clauses 1 to 17, wherein the heat exchanger has a corrosion resistance under the conditions of ASTM G85 Annex A3 (2019) of at least 20 days.
   19. The heat exchanger of any of clauses 17 to 18, wherein the heat exchanger is an oil cooler, a radiator, or a liquid cooled condenser.
   20. A method for forming an article, the method comprising:
contacting a first part comprising a first material with a second part comprising all or a portion of the brazing sheet of any of clauses 1 to 16; and
brazing the first part to the second part by a process comprising at least one of controlled atmospheric brazing and vacuum brazing.
   21. The method of clause 20, wherein the first material comprises aluminum or an aluminum alloy.
   22. The method of any of clauses 20 to 21, wherein the article is a heat exchanger.
   23. The method of any of clauses 20 to 22, wherein the article is an oil cooler, a radiator, or a liquid cooled condenser.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural and the use of a plural noun includes the singular, unless the context of the usage requires otherwise.

One skilled in the art will recognize that the herein described articles and methods, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken to be limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A brazing sheet comprising:
a core comprising an aluminum alloy; and
a brazing layer disposed on the core and comprising a 4XXX series aluminum alloy,
wherein the core acts as a sacrificial anode and the brazing layer acts as a cathode of a first galvanic circuit within the brazing sheet.

2. The brazing sheet of claim 1, further comprising:
an interliner layer intermediate the core and the brazing layer;
wherein the interliner layer acts as a cathode of the galvanic circuit relative to the core and the interliner layer acts as an anode of the galvanic circuit relative to the brazing layer.

3. The brazing sheet of claim 2, wherein
the core comprises a first concentration of a first cathodic material;
the brazing layer comprises a second concentration of a second cathodic material;
the interliner layer comprises a third concentration of a third cathodic material;
the second concentration is greater than the first concentration; and
the third concentration is greater than the first concentration and less than the second concentration.

4. The brazing sheet of claim 3, wherein the first cathodic material, the second cathodic material, and the third cathodic material are each individually selected from the group consisting of Cu, Zn, Mg, Mn, Si, Fe, Cr, Ti, Zr, V, Li, and combinations thereof.

5. The brazing sheet of claim 4, wherein the first cathodic material, the second cathodic material, and the third cathodic material are Cu.

6. The brazing sheet of claim 3, wherein
the third concentration is greater than the first concentration by at least 0.05 weight percent; and
the second concentration is greater than the third concentration by at least 0.05 weight percent.

7. The brazing sheet of claim 3, wherein the core comprises at least 0.01 weight percent of the first cathodic material.

8. The brazing sheet of claim 2, wherein
the core comprises, in weight percentages, 0.05 to 0.6 Cu;
the brazing layer comprises, in weight percentages, 0.25 Cu to 1 Cu; and
the interliner layer comprises, in weight percentages, 0.25 to 0.95 Cu.

9. The brazing sheet of claim 2, wherein the core, the interliner layer, and the brazing layer are bonded together.

10. The brazing sheet of claim 2, wherein the interliner layer is an aluminum alloy comprising, in weight percentages:
0.05 to 1.5 Si;
up to 2 Cu;
up to 0.5 Zr;
up to 0.8 Fe;
up to 2 Mn;
up to 3 Zn;
up to 2 Mg;
up to 0.3 Ti;
up to 1 Cr;
up to 0.5 Bi;
aluminum; and
impurities.

11. The brazing sheet of claim 2, wherein:
the brazing layer is a first brazing layer disposed on a first side of the core;
the interliner layer is a first interliner layer;
the galvanic circuit is a first galvanic circuit;
a second brazing layer is disposed on a second side of the core opposite the first side of the core, and comprises a 4XXX series aluminum alloy; and
a second interliner layer is disposed intermediate the core and the second brazing layer,
wherein the core acts as a sacrificial anode and the second brazing layer acts as a cathode of a second galvanic circuit within the brazing sheet.

12. The brazing sheet of claim 1, wherein the core comprises a 1XXX series aluminum alloy, a 3XXX series aluminum alloy, a 5XXX series aluminum alloy, or a 6XXX series aluminum alloy.

13. The brazing sheet of claim 1, wherein the brazing sheet is suitable for at least one of controlled atmospheric brazing and vacuum brazing.

14. The brazing sheet of claim 1, wherein the brazing layer is an aluminum alloy comprising, in weight percentages:
5 to 15 Si;
up to 2.0 Mg;
up to 1.0 Fe;
up to 3.0 Zn;
up to 3.0 Cu;
up to 1.0 Mn;
up to 1.0 Ti;
up to 0.01 Bi;
aluminum; and
impurities.

15. The brazing sheet of claim 1, wherein the core is an aluminum alloy comprising, in weight percentages:
up to 2.0 Si;
up to 0.8 Fe;
up to 1.0 Cu;
up to 1.8 Mn;
up to 1.0 Mg;
up to 2.0 Zn;
up to 0.25 Cr;
up to 0.15 Zr;
aluminum; and
impurities.

16. The brazing sheet of claim 1, wherein
the core comprises a first thickness in a range of 60% to 90% of a total thickness of the brazing sheet;
the interliner layer comprises a second thickness in a range of 3% to 20% of the total thickness of the brazing sheet; and
the brazing layer comprises a third thickness in a range of 3% to 20% of the total thickness of the brazing sheet.

17. A heat exchanger comprising a structural element comprising all or a portion of the brazing sheet of claim 1.

18. The heat exchanger of claim 1, wherein the heat exchanger has a corrosion resistance under the conditions of ASTM G85 Annex A3 (2019) of at least 20 days.

19. The heat exchanger of claim 17, wherein the heat exchanger is an oil cooler, a radiator, or a liquid cooled condenser.

20. A method for forming an article, the method comprising:
contacting a first part comprising a first material with a second part comprising all or a portion of the brazing sheet of claim 1; and
brazing the first part to the second part by a process comprising at least one of controlled atmospheric brazing and vacuum brazing.
